(19) United States
(12) Patent Application Publication
(10) Pub. No.: US 2010/0005265 A1
(43) Pub. Date: Jan. 7, 2010

(54) METHOD FOR ISOLATING OBJECTS IN MEMORY REGION

(75) Inventor: Rei Odaira, Kanagawa-ken (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 12/494,557

(22) Filed: Jun. 30, 2009

(30) Foreign Application Priority Data
Jul. 1, 2008 (JP) 2008-172110

(51) Int. Cl. G06F 12/14; G06F 12/00; G06F 12/02

(52) U.S. Cl. 711/163; 707/206; 711/165; 711/E12.001; 711/E12.002; 711/E12.093

(57) ABSTRACT

Method for isolating an object that has not been accessed for a certain period of time in a virtual memory space. When a garbage collection operates on a computer, the following steps are executed: detecting the object which has not been accessed for a certain period of time as a non-access object; moving the non-access object to a newly reserved virtual memory region when a certain time period elapses after detecting the non-access object; and setting the newly reserved virtual memory region to be an inaccessible region so that the garbage collection does not access the inaccessible region after a certain further time period elapses after moving the non-access object to the newly reserved virtual memory region.

### REFERENCE TO RELATED APPLICATION

This application claims priority under 35 U.S.C. 119 from Japanese Patent Application Number 2008-172110, filed Jul. 1, 2008, the entire contents of which are incorporated herein by reference.

### BACKGROUND OF THE INVENTION

1. Field of the Invention

The present invention relates to a method for isolating objects which have not been accessed for a predetermined time period in a memory region, in order for effective utilization of the memory region. In particular, the invention relates to a method for isolating objects in a heap memory.

2. Description of Related Art

In general, in a computer such as a PC, it is extremely inefficient both in cost and energy consumption to reserve an entire virtual memory space for a process in a physical memory, since this requires many memory modules. Hence, a virtual memory page that retains available data but has not been accessed for a long time should preferably be swapped out to a disk, or mapped to a memory of low speed but high energy efficiency. Hereinafter, “retaining available data” is referred to as being “alive” or “live.”

In a process such as Java (registered trademark), many objects are smaller than a page size. Accordingly, some objects that are alive within a single page of a heap memory have not been accessed for a long time and others have been accessed.

FIG. 13 illustrates a memory in which objects that are accessed and objects that are no longer accessed exist together in a virtual memory page. In FIG. 13, objects 11 with the X marks are accessed, while objects 12 without the X marks have not been accessed for a long time. As can be seen in FIG. 13, every virtual memory page 13 includes at least one accessed object (access object) 11, and thus it is not preferable that the virtual memory pages 13 be swapped out or mapped to a low-speed memory (not shown).

Moreover, in a process such as a Java (registered trademark) process, a so-called garbage collection (GC) process accesses each live object once every several seconds to several minutes. The GC process is a function for automatically releasing regions which are no longer necessary, among memory regions dynamically reserved by a program. For this reason, even if there are objects which have not been accessed by a user program for a long time (referred to as “non-access objects” below), the non-access objects should not preferably be swapped out or mapped to a low-speed memory.

Accordingly, when reducing physical memory usage in a process such as a Java process, it is desirable to separate non-access objects from other objects, and to allocate them in a different virtual memory page. At this time, non-access objects need to be selected with a high accuracy rate. Otherwise, a user program must access virtual memory pages swapped out to a disk or the like or mapped to a low-speed memory, which largely lowers the access speed of the user program.

Additionally, since a GC process operates in a process such as Java process, when an object is isolated, access to this object by the GC process needs to be inactivated.

A known method for monitoring and relocating recently-accessed objects is disclosed in Japanese Patent Application Publication No. 2006-92532. Here, data locality is improved by detecting a group of recently-accessed objects and locating the group in a single virtual memory page. The method of Japanese Patent Application Publication No. 2006-92532 thus enables separation between frequently accessed objects and the other objects.

M. D. Bond and K. S. McKinley, Tolerating memory leaks, UT Austin Technical Report TR-07-64, 2007 proposes a method of isolating objects which are alive but not accessed for a long time in a virtual memory space, and swapping out the objects to a disk. This method is targeted for programs in which memory leaks occur.

In this method, during a GC process, a bit of the header of every object and the least significant bit of the pointer of every object are set to 1. Then, a barrier code is inserted immediately before every object access in a user program, so that each of the above bits in the pointer and the header can be set to 0 when the object is accessed. Thus, objects that are not accessed can be detected between GC processes.

However, in the method disclosed in Japanese Patent Application Publication No. 2006-92532, non-access objects are only relocated, and not removed (separated) from a physical memory. As a result, the GC process accesses every live object and thus a problem occurs that the access speed cannot be improved.

Additionally in the method disclosed in Japanese Patent Application Publication No. 2006-92532, non-access objects are not selected with a high accuracy rate from among less-frequently accessed objects. Hence, there is a problem that it is difficult to effectively reduce physical memory usage.

As disclosed in M. D. Bond and K. S. McKinley, Tolerating memory leaks, UT Austin Technical Report TR-07-64, 2007, the execution speed of a program is lowered for an average of approximately nine percent, due to the overhead of the barrier code. Here, since the barrier code needs to be included in a program, a problem arises that it is extremely difficult to flexibly activate a detection structure for detecting non-access objects only when the physical memory amount becomes insufficient.

### SUMMARY OF THE INVENTION

According to an aspect of the present invention, a method is provided for isolating an object which has not been accessed for a predefined time period in a virtual memory region of a computer on which a garbage collection operates. The method is performed by the computer and includes the following steps: detecting an object which has not been accessed for the predefined time period; classifying the detected object as a non-access object; moving the non-access object to a reserved virtual memory region after a predetermined time period elapses after detection of the non-access object; setting the reserved virtual memory region to be an inaccessible region after the predetermined time period further elapses after moving the non-access object to the reserved virtual memory region; and preventing the garbage collection from accessing the inaccessible region.

In another aspect, the present invention is implemented as a computer program for causing a computer to execute processes corresponding to the aforementioned steps in the above object isolation method. The program can be provided by storing it into a recording medium such as a magnetic disk, an optical disk, a semiconductor memory to distribute the program, or by delivering the program over a network.

### BRIEF DESCRIPTION OF THE DRAWINGS

FIG. 1 is a diagram illustrating a state in which non-access objects are isolated by use of an object isolation method according to an embodiment of the present invention.

FIGS. 2A and 2B are diagrams describing how to move objects without increasing the physical memory amount in the object isolation method. FIG. 2A is a diagram illustrating a state in which non-access objects are collectively moved to a single virtual memory page, and FIG. 2B is a diagram illustrating a state in which the non-access objects are moved within the virtual memory page while being mapped to the same physical memory.

FIG. 3 is a diagram illustrating a state in which setting of access flags is incomplete.

FIG. 4 is a flowchart illustrating an algorithm for interpolating access flags by use of a heuristic.

FIG. 5 is a flowchart illustrating a function of mark_pointer_fields(object).

FIG. 6 is a flowchart which illustrates a function of interpolate_accessed_objects(object).

FIGS. 7A and 7B are diagrams illustrating a result of interpolating access flags by use of the heuristic. FIG. 7A is a diagram illustrating a result of mark_pointer_fields( ), and FIG. 7B is a diagram illustrating a result of interpolate_accessed_objects( ).

FIG. 8 is a diagram illustrating a state in which access to an object in a semi-inaccessible region is detected by a page protection mechanism.

FIGS. 9A and 9B are diagrams describing how to set an inaccessible region. FIG. 9A is a diagram illustrating the setting of a semi-inaccessible region, and FIG. 9B is a diagram illustrating how the semi-inaccessible region is set to be the inaccessible region and mapped to a memory having low speed but high energy efficiency.

FIGS. 10A and 10B are diagrams illustrating settings of the inaccessible region for preventing objects from being rewritten by a GC. FIG. 10A illustrates an example of mapping the inaccessible region to a memory having low speed but high energy efficiency, and FIG. 10B illustrates an example of inhibiting an object pointed by a copy from being moved.

FIG. 11 is a diagram illustrating an example of adding another inaccessible region.

FIG. 12 is a diagram illustrating an example of moving objects in an inaccessible region to a normal heap memory region.

FIG. 13 is a diagram illustrating a state in which objects which are accessed and objects which are no longer accessed are both present in a virtual memory page.

### DETAILED DESCRIPTION OF THE PREFERRED EMBODIMENT

The present invention includes a method for isolating an object which has not been accessed for a predefined time period in a virtual memory region, the method executed by a computer on which a garbage collection operates. The method includes: detecting the object which is not accessed for the predefined time period as a non-access object; moving the non-access object to a newly reserved virtual memory region when a certain time period elapses after detecting the non-access object; and setting, when a predetermined time period further elapses after moving the non-access object to the newly reserved virtual memory region, the newly reserved virtual memory region to be an inaccessible region and preventing the garbage collection from accessing the inaccessible region.

When a predetermined time period elapses after detecting a non-access object, the non-access object is moved to a newly reserved virtual memory region; and when a certain time period further elapses, the newly reserved virtual memory region is set to be an inaccessible region so that the garbage collection does not access the inaccessible region. Thus, the access speed is not deteriorated even when a garbage collection is activated.

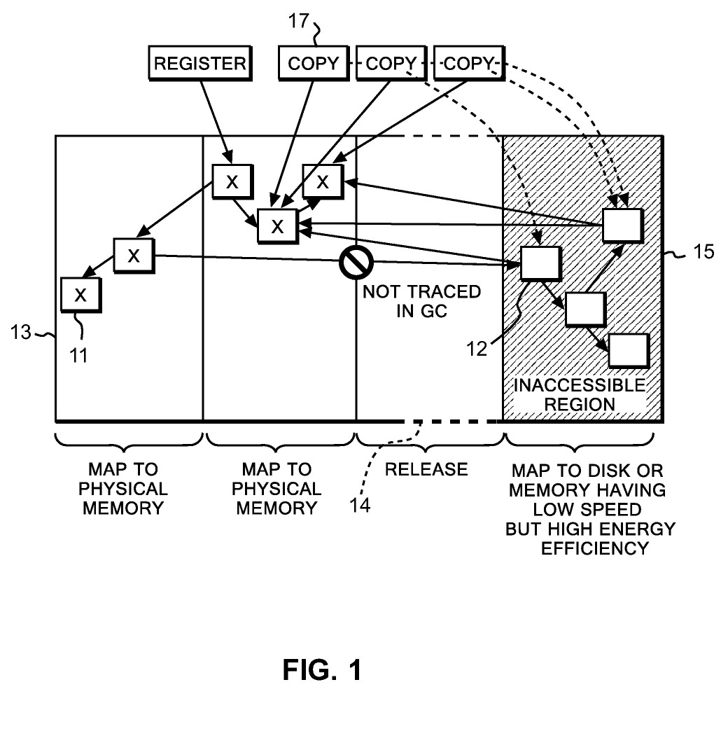

Referring to FIG. 1, a state where non-access objects are isolated is shown. First, when physical memory usage needs to be reduced in a computer, an object isolation function (not shown) is activated to set an access flag to each of objects which are assumed to have been accessed within a certain time period.

For copy, if the execution speed is not largely lowered, the most accurate method is to set an access flag for a target object for every load/store instruction to a heap memory (not shown). However, this method actually lowers the execution speed largely, and thus, as an approximation, the following objects are assumed to be accessed objects.

When there is at least one of: (1) an object for which a cache miss occurs; (2) an object accessed by a load/store instruction that is hit when performing sampling at every predetermined time period; (3) an object directly pointed by a register or a stack at the startup time of a GC process; (4) a newly generated object; (5) when using generational GC, an object in the young generation; and (6) when using generational GC, an object in the old generation directly pointing the young generation (an object in a write set of generational GC), the object isolation function judges that an object has been accessed. Since these methods do not require a barrier code in a user program, it is possible to activate the methods only for a specific time period.

After a certain time period, the object isolation function moves the objects without the access flags to a newly reserved virtual memory page. This virtual memory page is referred to as a semi-inaccessible region. If the time period is not sufficiently long, flags may not be set for some objects even if they are accessed. In this case, flags are also set to the objects connecting the objects with the flags for interpolation.

At this point, a physical memory is still mapped to the semi-inaccessible region, and the objects with the flags may be moved to a smaller region so that a physical memory that is no longer necessary can be released as shown in region 14 by a broken line in FIG. 1. The flags are then cleared from the objects.

The object isolation function checks whether objects in the semi-inaccessible region are not accessed by a user program during the elapse of a certain time period. Access to the entire semi-inaccessible region is inhibited by use of a page protection mechanism. In other words, the semi-inaccessible region is set to be an inaccessible region 15 indicated by the shaded portion in FIG. 1 and access is detected by a signal handler. Note that an object accessed by a user program is removed from the semi-inaccessible region and relocated in a normal heap memory.

As has been described, the semi-inaccessible region is set to be the inaccessible region 15 after the elapse of a certain time period. The inaccessible region 15 is not mapped to a physical memory, and the contents thereof are stored elsewhere, such as being written to a disk or being mapped to a memory having low speed but high energy efficiency.

Copies 17 of pointers pointing outward from the inaccessible region 15 are added to a root set of a GC process, so that the GC process is not required to access the inaccessible region 15. In addition, a GC algorithm is modified such that pointers to the inaccessible region are not followed.

As has been described, when there is a need to reduce physical memory usage, the object isolation function detects objects which are assumed to have been accessed within a certain time period, and sets an access flag to each of the objects. A bit in the header of each object may be used as the access flag. Instead, a table including the access flag bits may be provided in a memory region different from the heap memory.

As mentioned above, in the present embodiment, (1) an object for which a cache miss occurs, (2) an object accessed by a load/store instruction that is hit when performing sampling at every predetermined time period, (3) an object directly pointed by a register or a stack at the startup time of a GC process, (4) a newly generated object, (5) when using generational GC, an object in the young generation, and (6) when using generational GC, an object in the old generation directly pointing the young generation (an object in a write set of generational GC), are regarded as accessed objects.

(1) An Object for which a Cache Miss Occurs

An object for which a cache miss occurs is obviously an accessed object. As a part of a functionality of taking execution profiles, processors in recent years are capable of recording a virtual memory address when a data cache miss occurs. Moreover, control can be shifted to a profiling function once in a specified number of times of cache misses.

In the profiling function, a judgment can be made for each of the recorded virtual memory addresses on whether the address is within the heap memory. Thereafter, an object including the virtual memory address can be identified by use of the following method.

This method utilizes the fact that a pointer to a virtual function table is included at the head of each object. In the method, a word that can be regarded as a pointer to the virtual function table is searched by scanning down the memory from the obtained virtual memory address.

(2) An Object Accessed by a Load/Store Instruction that is Hit when Performing Sampling at Every Predetermined Time Period

Similar to the profiling of cache misses, the control can be shifted to a profiling function at every predetermined time period in many processors. In the profiling function, many processors are capable of obtaining an instruction that had been executed immediately before, and contents of a register.

If a load/store instruction had been executed immediately before, a virtual memory address that the load/store instruction had accessed can be obtained from the contents of the register, and an object can be identified by use of the same method as mentioned above.

### (3) An Object Directly Pointed by a Register or a Stack at the Startup Time of a GC Process

An object directly pointed by a register or a stack is assumed to have been accessed recently, or assumed to be accessed in the near future. Since objects pointed by a register or a stack are followed at the time of a GC, only a low additional execution cost is necessary to set an access flag to a directly-pointed object.

### (4) A Newly Generated Object

A newly generated object is highly likely to be accessed in the near future. Accordingly, a corresponding access flag is set at the time of generation of the object.

### (5) When Using Generational GC, an Object in the Young Generation

An object in the young generation is assumed to have been accessed recently, and is highly likely to be collected by a GC in the near future. Hence, this object should not be isolated in the inaccessible region. Whether an object belongs to the young generation or not can generally be judged from its address, and thus a flag does not need to be set actually.

### (6) When Using Generational GC, an Object in the Old Generation Directly Pointing the Young Generation (an Object in a Write Set of Generational GC)

An object in the young generation will be collected by a GC or will be moved to the old generation, in the near future. Accordingly, a field that is among an object in the old generation and directly pointing the young generation will be accessed in the near future, and be rewritten. Such a field is included in a write set of generational GC, so that an access flag can also be set easily to the object including the field, at the time of a GC.

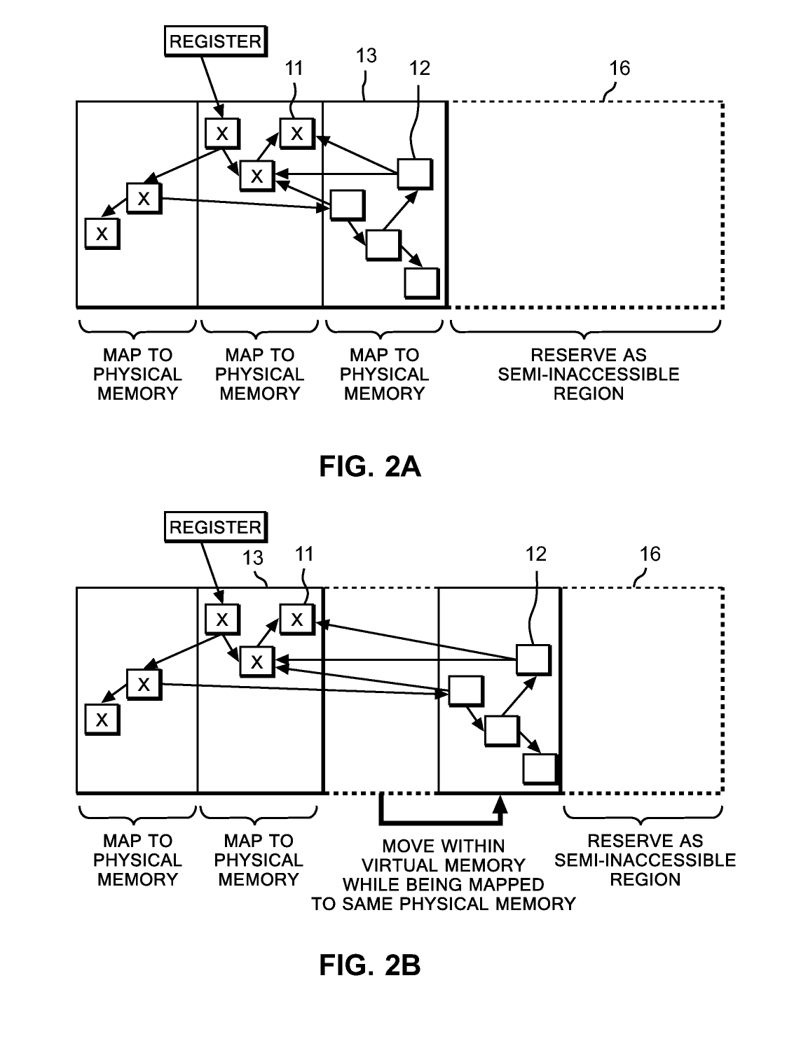

FIGS. 2A and 2B are diagrams for describing how to move objects without increasing the physical memory amount. Here, after the elapse of a certain time period, objects without the access flags are moved to the semi-inaccessible region. If the GC includes a mechanism for moving objects, it is desirable that the objects be moved by use of the mechanism. Accordingly, the objects may be moved concurrently with the GC, and when all the objects have been moved, all the access flags are cleared.

In the next and subsequent steps, it is necessary to facilitate a judgment on whether or not an object is included in the semi-inaccessible region from its address. For this reason, a continuous and large virtual memory region to be used as the semi-inaccessible region in the future is preferably reserved in advance by a system call similar to a memory map, at the time of startup.

At this point, the semi-inaccessible region needs to be mapped to the physical memory. Hence, in a simple implementation, the required physical memory amount temporarily increases. However, objects with the access flags are moved to a smaller region, and thus when all of the objects have been moved, a heap memory region that is no longer necessary can be released.

As the implementation for not increasing the required physical memory amount, first as shown in FIG. 2A, in the normal heap memory region, the objects 11 with the access flags and the objects 12 without the access flags are separated, by moving the objects 12 to a virtual memory page 13.

Subsequently as shown in FIG. 2B, the page including the objects 12 without the access flags is remapped, by support of the operating system (OS), to a virtual memory page reserved as a semi-inaccessible region 16. In other words, only the virtual memory address and not the physical memory address of the objects 12 is changed, as indicated by the bold line in FIG. 2B.

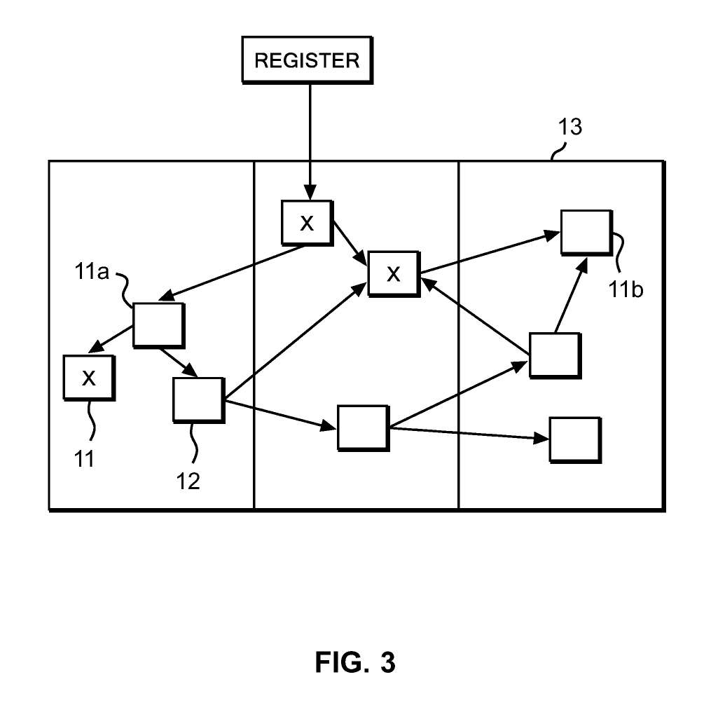

At this time, if the time period for setting the access flags to the objects 11 is not sufficiently long, the setting of the access flags remains incomplete as shown in FIG. 3. In the example of FIG. 3, assume that access flags are not set to objects 11a and 11b, even though the two have been accessed. Here, if the objects without the flags are moved to the semi-inaccessible region in this state, execution time is increased excessively in the next step.

In this case, access flags may also be set to the objects connecting the objects with the access flags for interpolation.

Hereinafter, a description is given of an algorithm for interpolating the access flags by use of a heuristic.

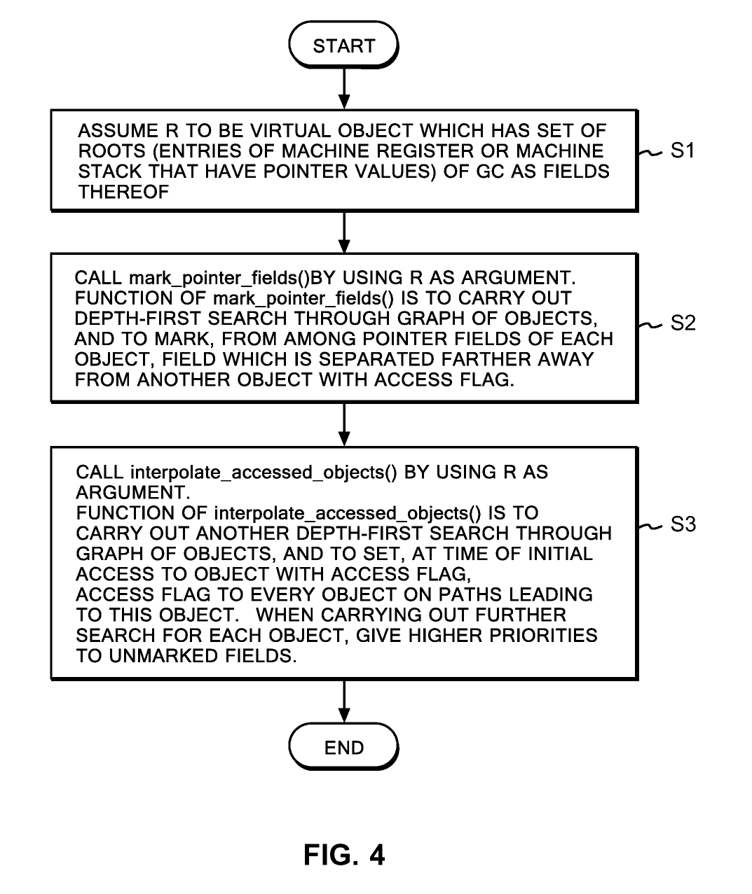

FIG. 4 is a flowchart illustrating an algorithm for interpolating the access flags by use of a heuristic. In FIG. 4, R is assumed to be a virtual object which has a set of roots (entries in a machine register or a machine stack that have pointer values) of a GC as fields thereof (step S1).

mark_pointer_fields( ) is called by using R as an argument. A function of mark_pointer_fields( ) is to carry out a depth-first search through a graph of objects, and to mark, from among pointer fields of each object, a field which is separated farther away from another object with an access flag (step S2). The least significant bit is used to mark the field.

interpolate_accessed_objects( ) is called by using R as an argument. A function of interpolate_accessed_objects( ) is to carry out another depth-first search through the graph of objects, and to set, at the time of initial access to an object with an access flag, an access flag to every object on the path leading to this object. When carrying out a further search for each object, unmarked fields are given higher priorities (step S3).

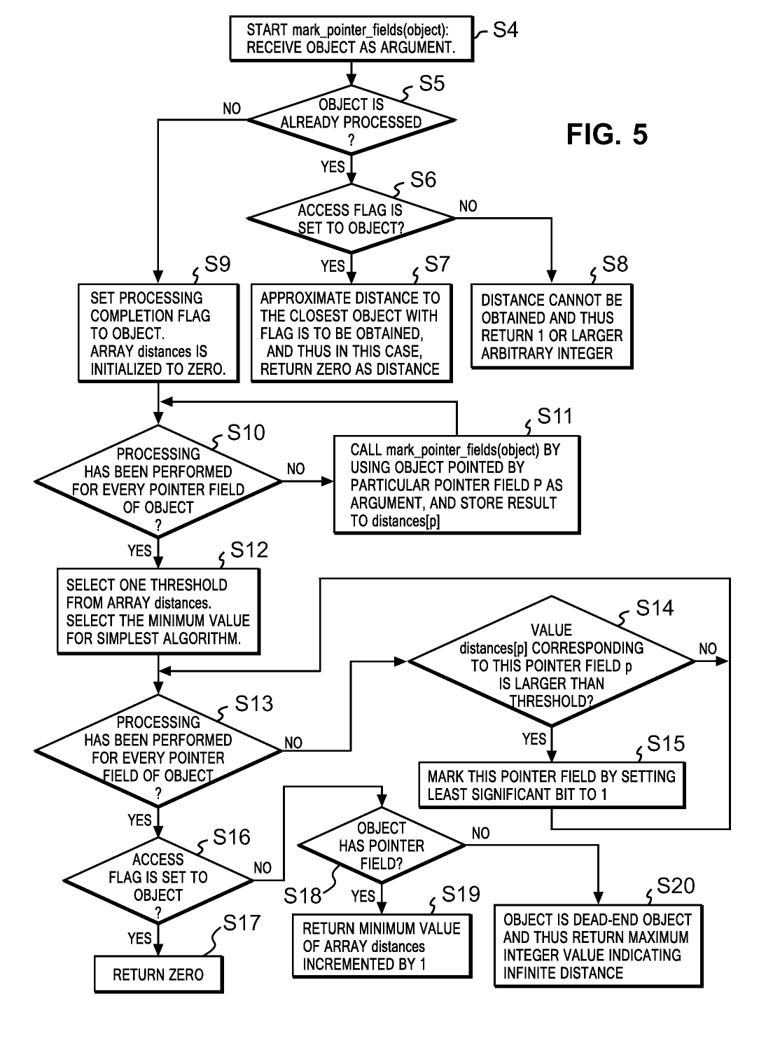

FIG. 5 is a flowchart illustrating a function of mark_pointer_fields(object). When mark_pointer_fields(object) is started in FIG. 5, an object is received as an argument (step S4), and it is judged whether or not the object is already processed (step S5).

If the object is already processed, it is then judged whether or not an access flag is set to the object (step S6). If an access flag is set, an approximate distance to the closest object with an access flag is supposed to be obtained. Thus in this case, zero is returned as the distance (step S7). Meanwhile if an access flag is not set, the distance cannot be obtained and thus 1 or a larger arbitrary integer is returned (step S8).

If the object is not already processed in step S5, a processing completion flag is set to the object and an array distances is initialized to zero, in step S9. Thereafter, it is judged whether or not processing has been performed for every pointer field of the object as illustrated in step S10. If the processing has not been performed, mark_pointer_fields(object) is called by using an object pointed by the particular pointer field p as an argument, and the result is stored to distances[p] (step S11). Then, the processing flow returns to step S10.

If processing has been performed for every pointer field of the object in step S10, a threshold is then selected from the array distances (step S12). Note that the minimum value is selected for the simplest algorithm.

A further judgment is made on whether or not processing has been performed for every pointer field of the object (step S13), and if not, it is judged whether or not a value distances[p] corresponding to this pointer field p is larger than the threshold (step S14). If the value is larger, this pointer field is marked by setting the least significant bit to 1 (step S15), and the processing flow returns to step S13. Incidentally, if the value distances[p] corresponding to the pointer field p is equal to or smaller than the threshold, the processing flow returns to step S13.

Meanwhile, if processing has been performed for every pointer field of the object in step S13, it is judged whether or not an access flag is set to the object (step S16). If an access flag is set, zero is returned (step S17). If an access flag is not set in step S16, it is judged whether or not the object has a pointer field (step S18).

If the object has a pointer field in step S18, the minimum value of the array distances incremented by 1 is returned (step S19). If the object does not have a pointer field, this means that the object is a dead-end object and thus the maximum integer value indicating an infinite distance is returned (step S20).

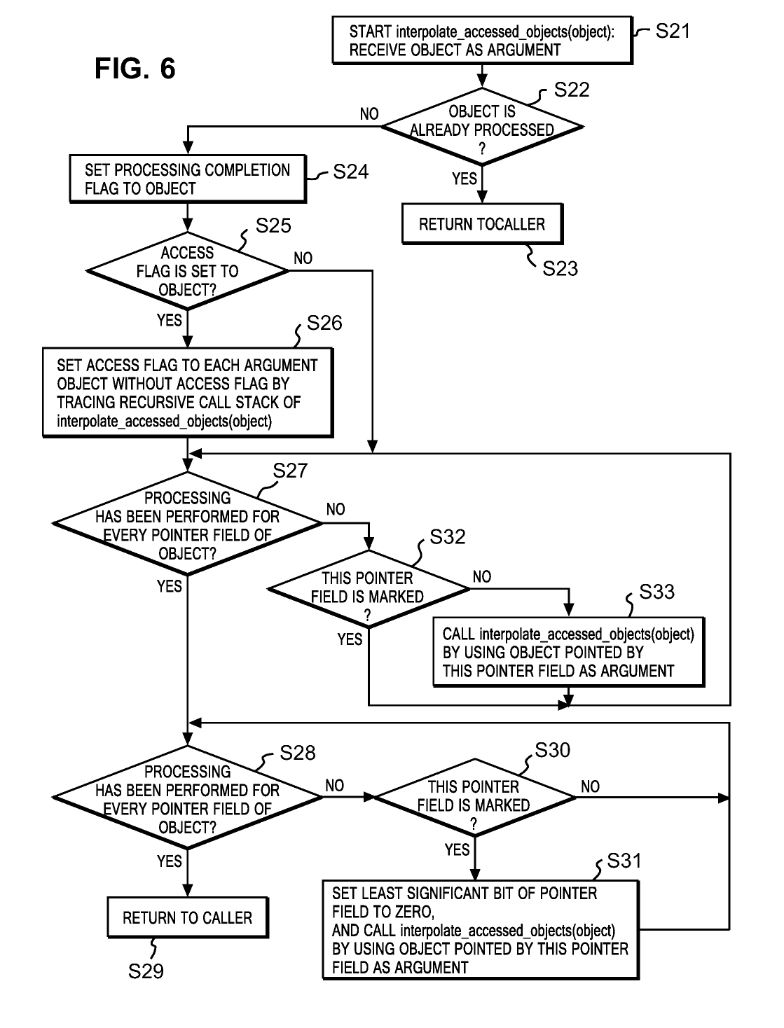

FIG. 6 illustrates a function of interpolate_accessed_objects(object). When interpolate_accessed_objects(object) is started in FIG. 6, an object is received as an argument (step S21), and it is judged whether or not the object is already processed (step S22).

If the object is already processed, the processing flow returns to the caller (step S23). If the object is not already processed, a processing completion flag is set to the object (step S24). Subsequently, it is judged whether or not an access flag is set to the object (step S25). If an access flag is set, an access flag is set to each argument object without an access flag by tracing a recursive call stack of interpolate_accessed_objects (object) (step S26).

Then, it is judged whether or not processing has been performed for every pointer field of the object (step S27). Incidentally, if an access flag is not set in step S25, the processing flow proceeds to step S27.

If processing has been performed for every pointer field of the object in step S27, it is again judged whether or not processing has been performed for every pointer field of the object (step S28). If the processing is completed, the processing flow returns to the caller (step S29).

If processing has not been performed for every pointer field of the object in step S28, it is judged whether or not each of the pointer fields that have not been processed is marked (step S30). If the pointer field is marked, the least significant bit thereof is set to zero, and interpolate_accessed_objects(object) is called by using an object pointed by this pointer field as an argument (step S31). The flow then returns to step S28. Incidentally, if the pointer fields are not marked in step S30, the processing flow returns to step S28.

If processing has not been performed for every pointer field of the object in the above-mentioned step S27, it is judged whether or not each of the pointer fields that have not been processed is marked (step S32). If the pointer field is marked, the flow returns to step S27.

Meanwhile, if the pointer field is not marked in step S32, interpolate_accessed_objects(object) is called by using an object pointed by this pointer field as an argument (step S33). The flow then returns to step S27.

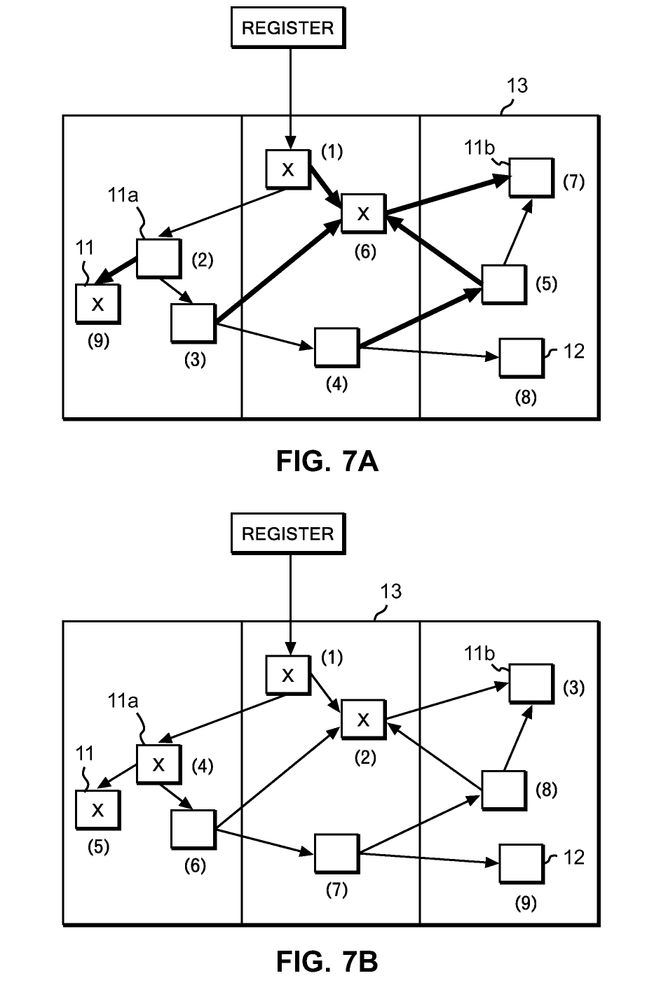

FIG. 7A shows an exemplar result of mark_pointer_fields( ). Here, assume that the minimum value of distance is used as a threshold. The numbers in brackets are an example of depth-first order, and bold arrows indicate pointers which have not been marked. In the next interpolate_accessed_objects( ), another depth-first search is carried out by giving priority to the unmarked pointers. The result is shown in FIG. 7B.

An access flag can be set to object 11a with this algorithm. Although an access flag cannot be set to object 11b, access to object 11b can be detected in a latter process.

Subsequently, a check is made to see whether objects in the semi-inaccessible region are not accessed for a long time period. It is necessary to check whether the objects that are moved to the semi-inaccessible region are not accessed for a long time period with high accuracy rate, since the aforementioned method of setting access flags is an approximation. For this reason, the entire semi-inaccessible region is further made inaccessible for a certain time period, except for when a GC is carried out, by use of a page protection mechanism.

When a user program accesses the semi-inaccessible region, control is shifted to a signal handler. An accessed virtual memory address can be obtained in a signal handler, and thus an object is identified to set an access flag. At the time of the next GC, an object with an access flag is returned to a normal heap memory region, and the flag is cleared.

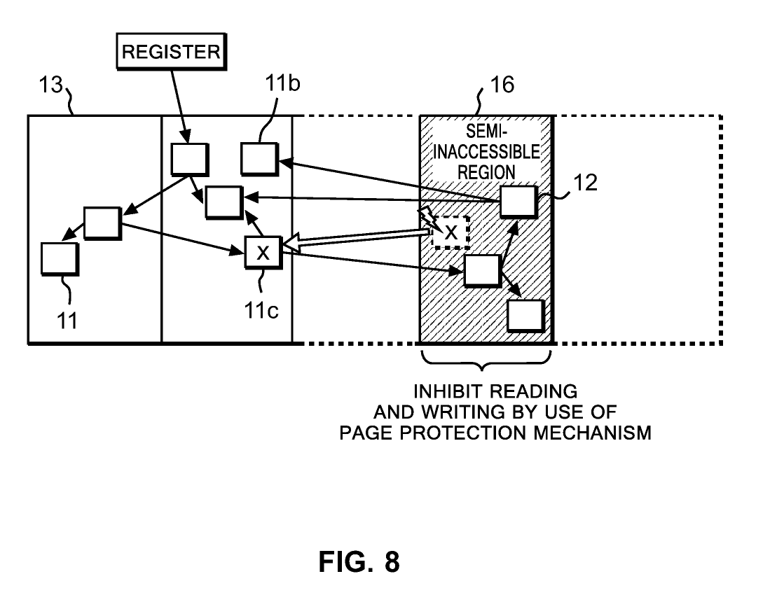

FIG. 8 shows a state subsequent to the state in FIG. 2. Object 11c is returned to a normal heap memory region since the object has been accessed. In addition, changes may occur in link relationships between objects during this time period, so that there may be an object such as object 11b in FIG. 8 that is only pointed from the semi-inaccessible region 16. Such an object 11b is moved to the semi-inaccessible region 16 as described below.

Subsequently, the semi-inaccessible region 16 is set to be the inaccessible region 15. After the elapse of a certain time period, the semi-inaccessible region 16 is actually removed from the physical memory as the inaccessible region 15. However, if, at this time point, a threshold number or more objects are returned to the normal heap memory from the semi-inaccessible region 16, the entire semi-inaccessible region 16 may be restored as a normal heap memory region instead of being removed from the physical memory.

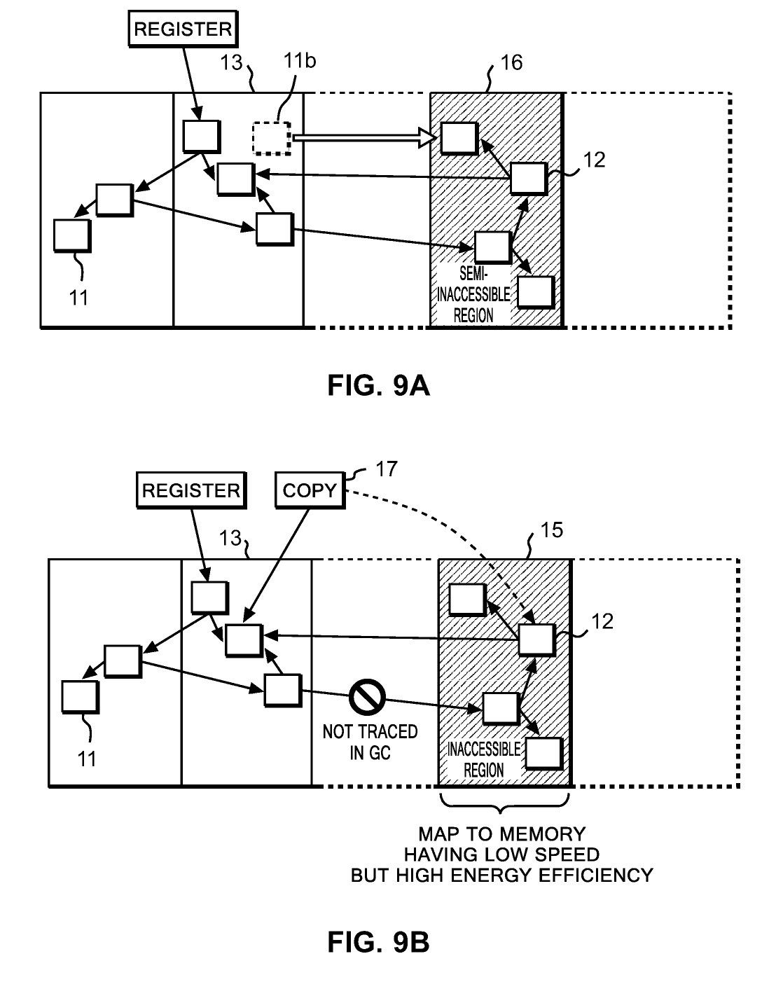

First as a preparation, an object that is only pointed from the semi-inaccessible region 16 is moved to the semi-inaccessible region 16, as shown in FIG. 9A. Specifically as similar to a GC, objects are marked by tracing a root set, while pointers pointing to the semi-inaccessible region 16 are not traced but recorded. Then, the remaining objects are traced by using the pointers to the semi-inaccessible region 16 as a root set. On finding an unmarked object in the normal heap memory, the object is recursively moved to the semi-inaccessible region 16.

If a pointer pointing outward from the semi-inaccessible region 16 is found in the above search and moving of objects, a copy 17 is registered to a root set of a GC. The copy 17 holds information on a reference origin and a reference destination of a corresponding pointer. If the copy 17 does not refer to the object, the object could accidentally be collected by a GC when the object is only pointed from the inaccessible region 15 in the future.

On completion of the search and moving of the objects, the semi-inaccessible region 16 is set to be the inaccessible region 15. There are three different methods for setting the inaccessible region 15 depending on where to store contents thereof. However, note that a GC does not trace pointers to the inaccessible region 15 in any of the methods.

FIG. 9B illustrates a case of mapping the inaccessible region 15 to a memory having low speed but high energy efficiency. In this case, although at a low speed, a user program can directly read and write from and to the inaccessible region 15 upon access. However, note that reading and writing by a user program may be detected by inhibiting the reading and writing through a page protection mechanism.

When an object pointed by a copy 17 is moved by a GC, a field of an object in the inaccessible region 15 which refers to the moved object also needs to be rewritten. However, the object that needs to be rewritten is only a portion of the entire objects in the inaccessible region 15. This method requires a writing operation to the inaccessible region 15 for every movement of an object, and thus is not suited for the case of swapping out the inaccessible region 15 to a disk.

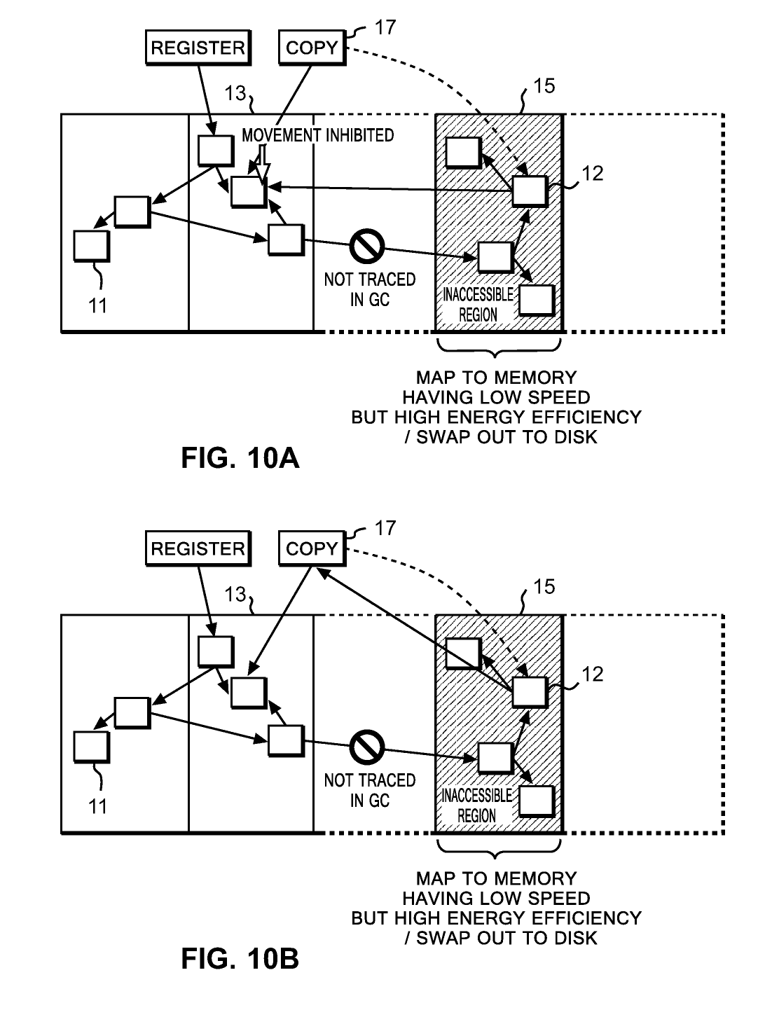

In order to prevent the objects from being rewritten by a GC, one of two types of settings respectively illustrated in FIGS. 10A and 10B is used.

In the setting illustrated in FIG. 10A, an object pointed by the copy 17 is inhibited from being moved. Accordingly, fragmentation could possibly occur in the heap memory region. In the case of mapping the inaccessible region 15 to a memory having low speed but high energy efficiency, a user program can directly read and write therefrom and thereto. In the case of swapping out the inaccessible region 15 to a disk, reading and writing from and to the region is inhibited by use of a page protection mechanism. In this case, when the user program accesses the inaccessible region 15, the region needs to be temporarily swapped in to a physical memory.

In the setting illustrated in FIG. 10B, when the semi-inaccessible region 16 is set to be the inaccessible region 15, a pointer pointing outward from the inaccessible region 15 is rewritten so as to point to a corresponding copy 17. Since the position of the copy 17 in the virtual memory space is not changed, an object in the inaccessible region 15 does not need to be rewritten even if an object pointed by the copy 17 is moved.

However, the user program cannot directly read or write from and to the inaccessible region 15, and thus reading and writing therefrom and thereto are inhibited by use of a page protection mechanism. Then, if the user program accesses the inaccessible region 15, the region needs to be temporarily swapped in to a physical memory to correctly rewrite the pointer by use of the information of the copy 17.

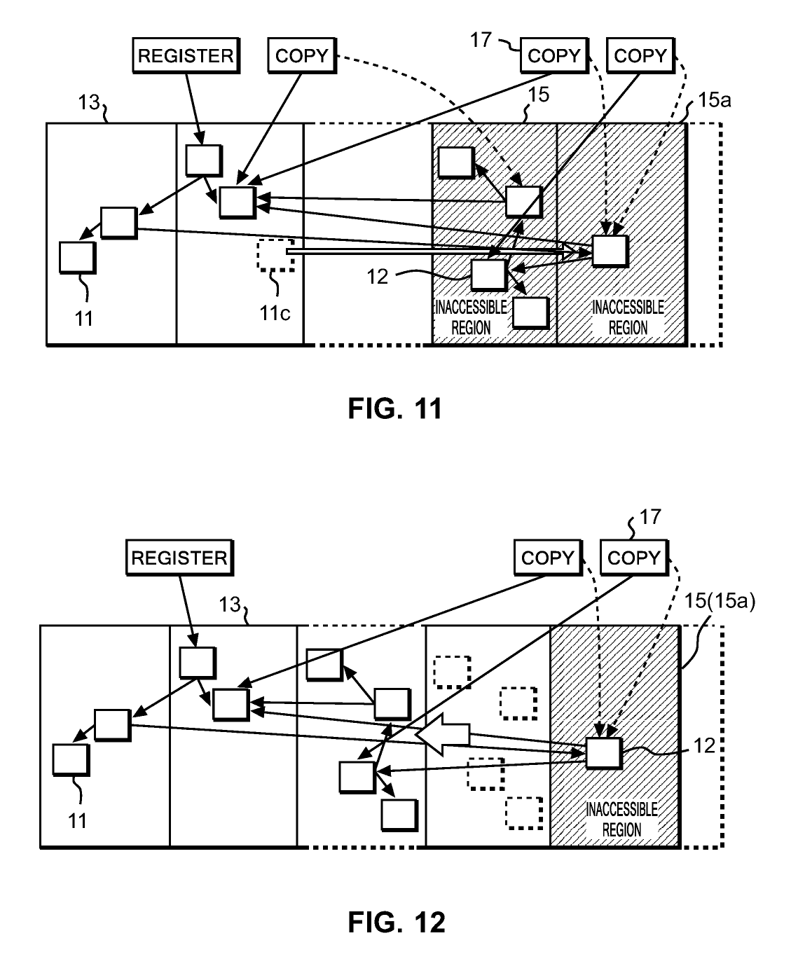

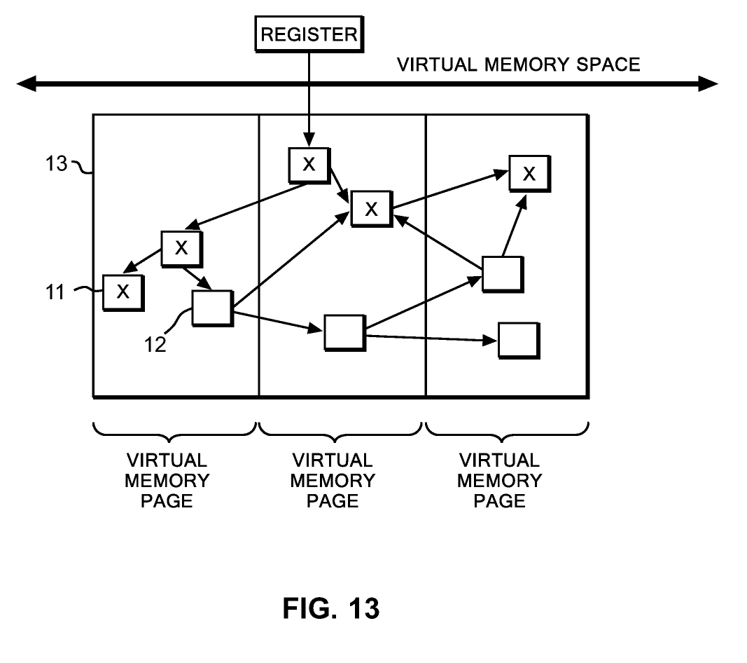

No object is newly added to an inaccessible region 15 that is already set, so that existing inaccessible regions 15 can be accessed as less frequently as possible. When a non-access object is newly detected, another inaccessible region 15a is set as shown in FIG. 11. Here, the copy 17 is generated for a pointer pointing outward from the new inaccessible region 15a, regardless of whether the pointer is pointing to a normal heap memory or to another inaccessible region 15.

In the case of inhibiting reading and writing from and to the inaccessible regions 15 and 15a by use of a page protection mechanism, it is possible to monitor accesses from a user program. If the regions are frequently accessed, all of the objects in the inaccessible regions 15 and 15a may be returned to a normal heap memory region. An exemplar state is illustrated in FIG. 12. Here, copies 17 corresponding to the inaccessible regions 15 and 15a are deleted.

Hence, according to the present embodiment, the access speed is not deteriorated even with accesses from a user program. Moreover, the access speed is not deteriorated since access by a garbage collection is not required for the isolated object. Not only physical memory usage can be reduced efficiently, but also non-access objects can be detected and isolated in accordance with the physical memory usage amount.

According to the present invention, in a computer on which a garbage collection operates, an object that is not accessed for a certain long period of time in a virtual memory region is detected as a non-access object. When a certain time period elapses after detecting the non-access object, the non-access object is moved to a newly reserved virtual memory region; and when a certain time period further elapses after moving the non-access object, the newly reserved virtual memory region is set to be an inaccessible region so that the garbage collection does not access the inaccessible region. Accordingly, physical memory usage can be reduced efficiently, while the access speed is not deteriorated since access by a garbage collection is not required for the isolated object once it is isolated. Not only physical memory usage can be reduced efficiently, but also non-access objects can be detected and isolated in accordance with the physical memory usage amount.

Although the preferred embodiment of the present invention has been described in detail, it should be understood that various changes, substitutions and alterations can be made therein without departing from spirit and scope of the invention as defined by the appended claims.

What is claimed is:

1. A computer implemented method for isolating an object which has not been accessed for a predefined time period in a virtual memory region of a computer on which a garbage collection operates, the method comprising the following steps:
detecting an object which has not been accessed for the predefined time period;
classifying the detected object as a non-access object;
moving the non-access object to a reserved virtual memory region after a predetermined time period elapses after detection of the non-access object;
setting the reserved virtual memory region to be an inaccessible region after the predetermined time period elapses again after moving the non-access object to the reserved virtual memory region; and
preventing the garbage collection from accessing the inaccessible region thereby isolating the object which had not been accessed for the predefined time period.

2. The method according to claim 1, wherein the detecting step comprises:
setting an access flag for an object which is accessed within the predefined time period in order to distinguish it from the non-access object.

3. The method according to claim 2, wherein the detecting step is initiated when physical memory usage needs to be reduced.

4. The method according to claim 2, wherein, in the detecting step, an access flag is set to a target object of every load/store instruction.

5. The method according to claim 2, wherein the detecting step comprises:
determining that the detected object is not:
an object for which a cache miss occurs;
accessed by a load/store instruction that is hit when performing sampling at every constant time period;
directly pointed to by any one of a register or a stack at the startup time of a garbage collection;
newly generated;
a young generation when generational garbage collection is employed; or
an old generation and directly points to the young generation when generational garbage collection is used.

6. The method according to claim 1, wherein the moving step comprises:
flagging the reserved virtual memory region as a semi-inaccessible region;
moving the non-access object to the semi-inaccessible region; and
releasing a portion of a physical memory that is no longer necessary.

7. The method according to claim 6, wherein the flagging step comprises:
setting the semi-inaccessible region to be the inaccessible region if a user program does not access the object in the semi-inaccessible region; and
moving the accessed object back outside the semi-inaccessible region if the user program accesses the object in the semi-inaccessible region.

8. The method according to claim 7, wherein a content of the inaccessible region is stored to a memory other than the physical memory.

9. The method according to claim 7, wherein a copy of a pointer pointing outward from the inaccessible region is added to a root set of the garbage collection, so that the garbage collection does not access the inaccessible region.

10. The method according to claim 7, wherein the garbage collection is modified such that the inaccessible region is not accessed.

11. A computer-readable storage medium tangibly embodying computer-executable program instructions which, when executed, cause a computer on which garbage collection operates to isolate an object which has not been accessed for a predefined time period in a virtual memory region, the method comprising the steps of:
detecting an object which has not been accessed for the predefined time period;
classifying the detected object as a non-access object;
moving the non-access object to a reserved virtual memory region after a predetermined time period elapses after detection of the non-access object;
setting the reserved virtual memory region to be an inaccessible region after the predetermined time period further elapses after moving the non-access object to the reserved virtual memory region; and
preventing the garbage collection from accessing the inaccessible region thereby isolating the object which had not been accessed for the predefined time period.
